(19) United States
(12) Patent Application Publication
(10) Pub. No.: US 2007/0174099 A1
(43) Pub. Date: Jul. 26, 2007

(54) PERSONNEL PERFORMANCE MONITORING SYSTEM AND METHOD

(76) Inventors: Silvio Artur Koin OSTROSCKI, Ottawa (CA); Eduardo de Lello FONSECA, Ottawa (CA); Salomao ROTENBERG, Sao Paulo (BR)

Correspondence Address: Dennis R. Haszko;Patent Law Office of D.R.Haszko, 499 MOSHER HILL ROAD, FARMINGTON, ME, 04938-5405, US

(21) Appl. No.: 11/624,776

(22) Filed: Jan. 19, 2007

(30) Foreign Application Priority Data
Jan. 26, 2006 (CA) 2535070

(51) Int. Cl. G06F 9/44; G08B 23/00

(52) U.S. Cl. 705/7; 340/573.1

(57) ABSTRACT

A system and method for monitoring and managing personnel performance, particularly security personnel, providing real time, ongoing and geographical response information enabling employers or service providers to conduct performance analysis on their personnel, to create a global and/or local response performance record and to facilitate the taking of the necessary steps, based on the generated information, to make modifications to their service and human resources if flaws or problems are found.

### FIELD OF THE INVENTION

The present invention relates to a personnel monitoring and managing method and system.

### BACKGROUND OF THE INVENTION

A reliable and efficient human resource management, especially in relation to security personnel, is becoming more and more one of the most important components of every organization. Security companies providing services are expected to guarantee as much as possible that, independently of the equipment used, their personnel should be trained and in fact be constantly alert to report or act whenever necessary. This personnel awareness is a critical component and requires constant monitoring to ensure reliable and proper performance.

Patents in the prior art disclose several types of control and/or generation of an alarm signal or identification in the case of an occurring problem or a potential problem. Such patents disclose the use of linkage between the monitored person or location and the monitoring unit location, whereby a reaction is triggered or impeded from those monitoring units depending on the signal, identification or information generated by the monitored location or person.

Also, a large number of intrusion detection systems are described in the prior art, some linked to a response team or device that is meant to immediately react to the triggering of the alarm.

In U.S. Pat. No. 3,611,344, Couper discloses a system for initiating conscious activity of a vehicle operator utilizing a visual alarm signal which is automatically and periodically activated and which signal must be promptly manually deactivated by the operator to prevent activation of an audio alarm signal which in turn must be promptly manually deactivated by the operator to prevent simultaneous activation of external emergency flashing lights, an automobile horn and an engine deactivator which temporarily deactivates the vehicle engine. Couper provides a system for protecting the operators and the vehicles from physical impairment, arranged to periodically test the operator's alertness, reaction time and ability to act, permitting all normal maneuvers when the operator properly reacts, but stopping the vehicle when the operator does not properly react.

In U.S. Pat. No. 3,982,238, Byers discloses a monitoring system for the notification of locations external to the area being monitored of a prolonged absence of motion within the area being monitored. The system consists of a clock, an electronic counter designed to record the pulses emitted periodically by the clock and to signal an alarm trigger when a pre-programmed number of pulses is recorded, and reset means such that if activated the counter will return to zero thereby preventing activation of the alarm trigger.

In U.S. Pat. No. 4,524,243, Shapiro discloses a personal alarm system operative to provide a warning at a central monitoring station indicative of subscriber inactivity. In Shapiro, the subscriber station transmits an alert message to the monitoring station over the communication link if the subscriber fails to reset clock logic via a reset switch or activity sensor within a predetermined time interval. An annunciator may be activated at the subscriber station coincident with transmission of the alert message. If the subscriber fails to activate a reset switch or a selected activity sensor within a predetermined period, the monitoring station provides an inactivity alarm indication to an operator who will take appropriate action.

In U.S. Pat. No. 4,743,892, Zayle discloses a monitoring system to confirm the presence or absence of a monitored individual through that individual's prescribed activity at a particular site at one or more pre-set times during a day. The on-site station has a signal generating device pre-settable to at least one particular time of day at which time the signal generating device emits an on-site signal for a period of time beginning at the pre-set time. The signal generating device can be manually deactivated during this period of time, but if it is not, the signal generating device activates the automatic communicator, which causes notification thereof to the central station, which identifies the notification and retrieves and displays pre-collected data on the monitored individual including instructions to be followed. Monitoring personnel can then follow these instructions, which can include calling the site, notifying a parent or the police or the like.

In U.S. Pat. No. 4,891,650, Sheffer discloses a system for determining a location of a selected vehicle from which an alarm signal is generated, which includes a fixed array of cellular sites each having wireless signal detecting and generating units, each of which is capable of receiving an input alarm signal having a signal strength which is a function of the distance between the position of the vehicle generating the alarm signal and the position of each of the wireless signal detecting units.

In U.S. Pat. No. 5,045,839, Ellis et al. a personnel activity sensor and alarm system is disclosed which incorporates one or more remote personnel safety units each incorporating a multi-axis motion detector and reset timing and logic circuit coupled with a radio transmitter or transceiver. Under the command of the logic circuit, the radio automatically transmits an alarm signal and causes the circuitry to generate a local audio signal in the event of personnel inactivity for a predetermined period of time, enabling personnel assistance to be initiated without delay.

Canadian Application CA 2,203,302 to Ranking Research Co. discloses a location method for a stolen vehicle equipped with a cellular transceiver. The method provides for determining that the vehicle has been stolen, paging the transceiver within the vehicle to open a voice channel, and estimating the location of vehicle based on the location of cell sites communicating with the transceiver.

In U.S. Pat. No. 6,774,765, Goodwin discloses a system and method of dispatching an individual in a transaction establishment which employs a communication system and pagers.

In U.S. Pat. No. 5,742,233, Hoffman et al disclose a personal security and tracking system comprising a portable signalling unit, a remote alarm switch device, a central dispatch station, and a wireless communication system such as a cellular or telephone system, etc., and a GPS or like system. The portable signaling unit and the remote alarm switch may be adapted to be worn at different locations on the person's body. The remote alarm switch may be concealed in the form of a wristband or in the form of any other object such as a brooch, pendant, or keychain. When the person in distress activates the remote alarm switch or when the remote alarm switch is removed from the individual by a forceful or unauthorized action or when the signalling unit is removed from the proximity of the remote alarm switch, the portable signalling unit sends a data transmission which includes its location to the central dispatch station.

In U.S. Pat. No. 5,189,395, Mitchell discloses an electronic house arrest monitoring (EHAM) system which allows a monitoring officer, charged with the responsibility of making periodic and/or random physical checks with individuals whose presence at specific locations is being electronically monitored through the EHAM system, to immediately and silently report to a central monitoring location that backup assistance is needed at the monitoring location.

The current prior art methods and devices are related to alarm reception and identification to generate an emergency or immediate response to attend to a problem. Other patents of the prior art use devices and methods mainly to trigger an alarm or signal to obtain an immediate reaction or to trigger a responsive action from authorities or a competent person or team. Other patents are focused on finding and tracking people and/or objects, especially stolen cars. However none of these prior art methods and systems shows a method of identifying the performance of personnel or a specific individual, especially at a specific location, in terms of alertness, or of identifying flaws and allowing for corrections of any identified problem of this nature.

Further, none of these prior art references describes systems or methods for monitoring and managing personnel performance or generating information based on performance as basic information for managing decisions to improve the services provided.

What is needed therefore is a system to monitor and manage personnel, particularly security personnel, geographically and on a real-time and on-going basis, to create a performance database and to use the database as input and as a basis to improve the services provided.

### SUMMARY OF THE INVENTION

The present invention seeks to provide a system and method for monitoring and managing personnel performance, of each of a plurality of subject individuals, particularly security personnel, in each of a plurality of monitored locations, providing individual real-time, ongoing and geographical response information and database, to enable service providers to prepare performance reports on their personnel in order to create a global and/or local individual and team response performance. Based on these databases or reports, the service provider is enabled to take the necessary steps, applying the generated information, to make modifications to its service and human resources if flaws or problems are found.

Such steps include, but are not limited to, creating an alert system where critical periods, locations and/or individuals are identified by the database. Alternatively any kind of extra activities can be created to maintain alert individuals identified by the database as critical individuals.

In this invention signals are randomly generated and transmitted to a signal emitter on-site or at a location where these signals are then emitted. Each individual is required to note and register the occurrence of the emitted signals or, in the alternative, response signals from the individual should be generated within a predetermined time after the signals are emitted or displayed. Data related to the existence of the registrations, response signals and non-existence of both are then received and stored and compared with the randomly generated signals data, and reported and monitored for managing purposes.

The signals may be generated at a remote location and transmitted to a location where each individual to be monitored is located or may be generated at the location where each individual to be monitored is located.

In use of the method and system, a plurality of random signals is generated during a predetermined monitoring period of time. The generated signals will be stored creating a first set of data. The existence and non-existence of response signals or registration of the occurrence of the emitting of the signals creates a second set of data, identifiable to specific individual and locations. The second set of data is then compared with the first set of data to determine the performance of each individual at each location during the predetermined monitoring period of time.

In one aspect, the present invention seeks to provide a system for monitoring and managing personnel performance, the system constructed and arranged to monitor each of a plurality of individuals in each of a plurality of monitored locations, comprising:

i. a signal generator for randomly generating signals during a predetermined monitoring period;

ii. means for storing a record of the generated signals during the predetermined monitoring period as a first set of data;

iii. a transmitter for transmitting the generated signals to a signal emitter at each location;

iv. means for generating a predetermined response to each of the signals in a predetermined way each time a subject individual generates a response to one of the generated signals;

v. means for storing the responses generated by each subject individual during the predetermined monitoring period as a second set of data;

vi. means for comparing the first and second set of data at the end of the predetermined monitoring period; and

vii. means for generating an individual performance database in relation to each monitored location during the predetermined monitoring period.

In another aspect, the present invention seeks to provide a method for monitoring and managing personnel performance, the method comprising monitoring each of a plurality of individuals in each of a plurality of monitored locations, comprising the steps of:

(a) randomly generating a signal;

(b) storing a record of the generated signal as part of a first set of data;

(c) transmitting the generated signal to a signal emitter at each location;

(d) emitting the signals at each location;

(e) identifying whether a response is generated by the subject individual;

(f) receiving and storing as part of a second set of data any response identified in step (e);

(g) repeating steps (a) to (f) during a predetermined monitoring period;

(h) comparing the second set of data with the first set of data;

(i) generating a database with the individual performance in relation to each individual at each location during the predetermined monitoring period, and

(j) generating remedial actions based on the database.

### BRIEF DESCRIPTION OF THE DRAWINGS

The invention will now be described with reference to the drawings, in which

FIG. 1 is a block diagram of a first preferred embodiment of the monitoring system of the invention;

FIG. 2 is a flowchart of a first preferred embodiment of the method of the invention;

FIG. 3 is a block diagram of a second preferred embodiment of the monitoring system of the invention; and

FIG. 4 is a flowchart of a second preferred embodiment of the method of the invention.

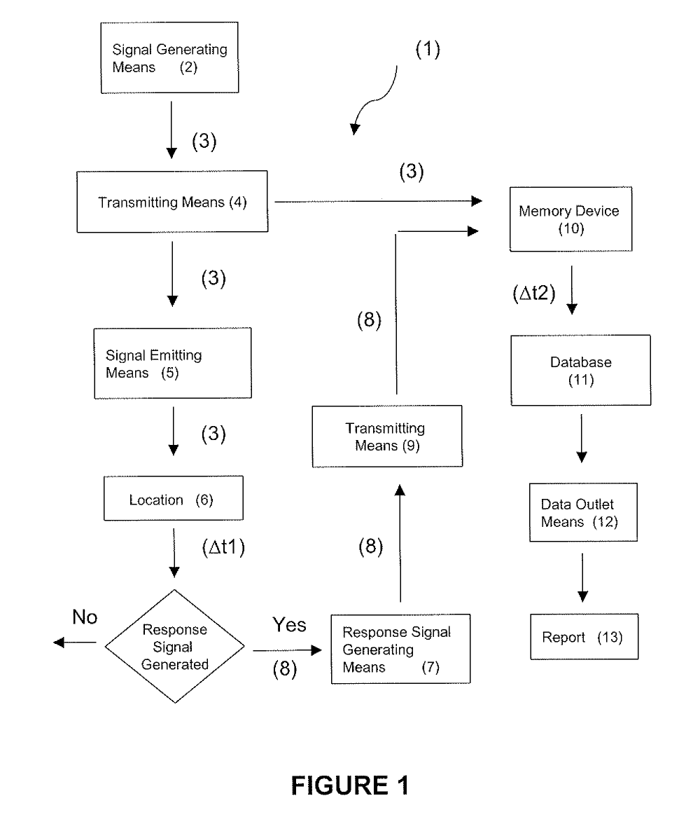

FIG. 1 is a block diagram of a first preferred embodiment of the monitoring system, showing the operation with one location and one individual in that location. In the monitoring system (1) a signal generator (2) randomly generates a signal (3) which is transmitted through a transmitter (4) to a computer readable memory device where is recorded and stored (10) and to a signal emitter (5) at a location (6) where the individual is located. The emitter is activated and will emit a signal each time a signal from the signal generator is received. If a predetermined response (8) to the signal (3) from the individual occurs within the predetermined interval (Δt1) after the signal is emitted at the location, a response signal is generated by a response signal generator (7) at the location and is transmitted by a response signal transmitter (9) to the computer readable memory device (10). The response signal is recorded and stored in the computer readable memory device (10).

After a plurality of random signals is generated during a predetermined monitoring period of time (Δt2) the information regarding the recording of the generation of the random signals during the monitored period of time is stored in the memory device as a first set of data, and the information regarding the recording of the existence of response signals within the predetermined monitoring period of time is also stored in the memory device as a second set of data.

The computer readable memory device then compares the second set of data with the first set of data and an individual performance database (11) is generated with information regarding the performance of the subject individual at the subject location during the monitored predetermined period of time (Δt2).

Optionally, a data outlet means (12) linked to the memory device (10) generates a report (13) indicating the detected and qualified information data of the results. The report may be adapted to and configured in any desired form.

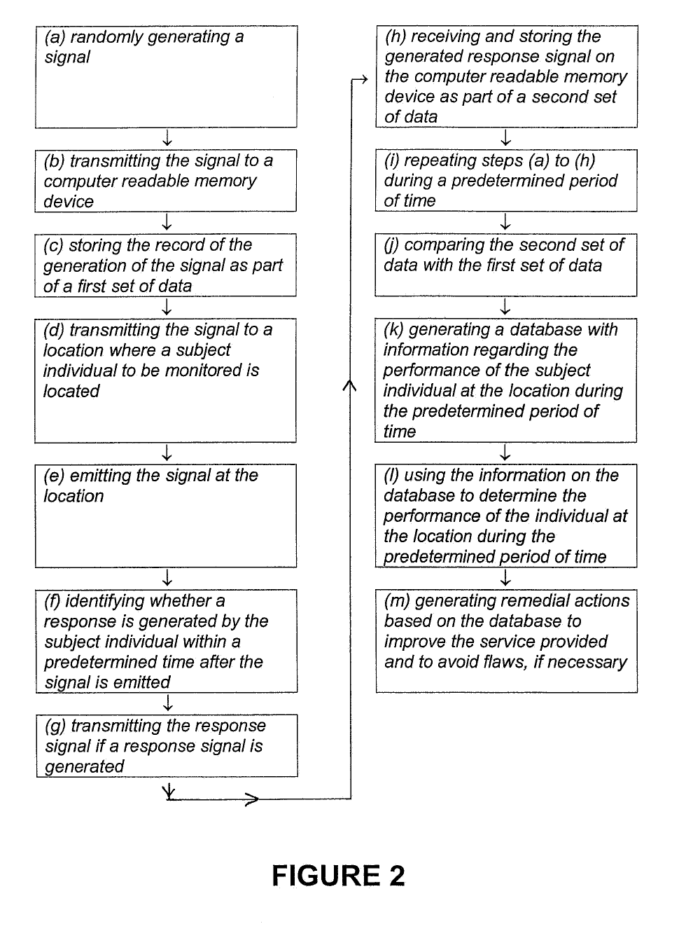

In FIG. 2 a flowchart illustrates the monitoring method of a first preferred embodiment of this invention shown in operation with one location and one individual at that location. Thus the method starts with (a) randomly generating a signal; (b) transmitting the signal to a computer readable memory device; (c) storing the record of the generation of the signal as part of a first set of data; (d) transmitting the signal to a location where a subject individual to be monitored is located; (e) emitting the signal at the location; (f) identifying whether a response is generated by the subject individual within a predetermined time after the signal is emitted; (g) transmitting the response signal if a response signal is generated; (h) receiving and storing the generated response signal on the computer readable memory device as part of a second set of data; (i) repeating steps (a) to (h) during a predetermined monitoring period of time; (j) comparing the second set of data with the first set of data; (k) generating a database with information regarding the performance of the subject individual at the location during the predetermined period of time; (l) using the information on the database to determine the performance of the individual at the location during the predetermined period of time, and (m generating remedial actions based on the database to improve the service provided and to avoid flaws, if necessary.

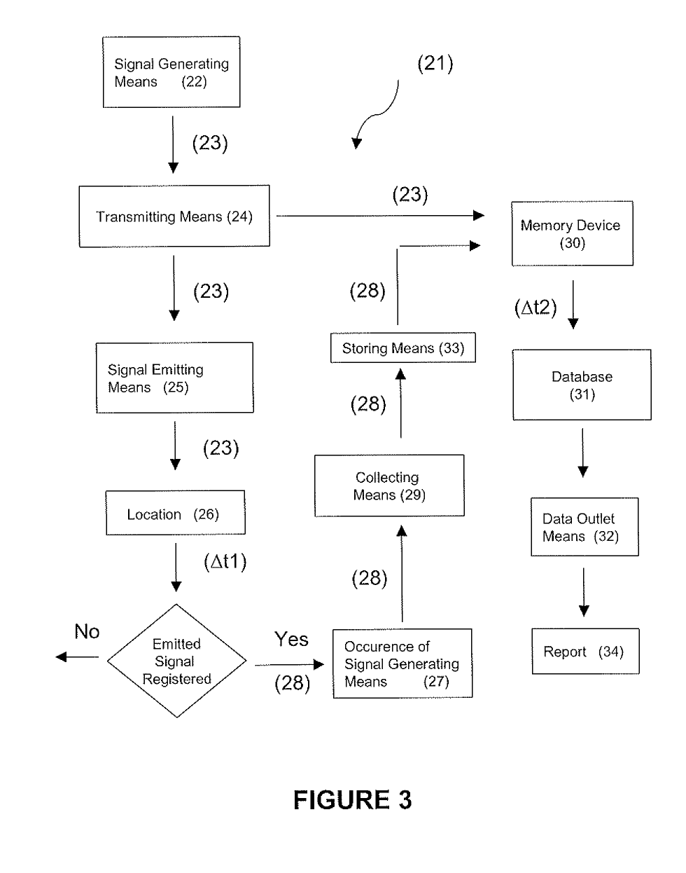

FIG. 3 is a block diagram of a second preferred embodiment of the monitoring system shown in operation with one location and one individual in that location. In the monitoring system (21) of a second embodiment of this invention a signal generator (22) randomly generates a signal (23) which is transmitted through a transmitter (24) to a computer readable memory device where is recorded and stored (30) and to a signal emitter (25) at a location (26) where the individual is located. The emitter is activated and will emit a signal each time it receives a signal from the signal generator.

Registration (28) of the occurrence of the emitting of the signal (23) may be performed by the individual through any suitable signal registration means (27). The registered information is then collected by any information collecting means (29). The information is recorded and stored by any storing means (33) in the computer readable memory device (30).

After a plurality of random signals is generated during a monitored period of time (Δt2) the information regarding the recording of the generation of the random signals during the monitored period of time is stored in the memory device (30) as a first set of data, and the information regarding the recording of the existence or non-existence of registration of the signals within the predetermined monitoring period of time is also recorded and stored in the memory device as a second set of data.

The computer readable memory device then compares the second set of data with the first set of data and an individual performance database (31) is generated with information regarding the performance of the subject individual at the subject location during the monitored predetermined period of time.

Optionally, a data outlet means (32) linked to the memory device (30) generates a report (34) indicating the detected and qualified information data of the results. The report may be adapted and configured in any desired form.

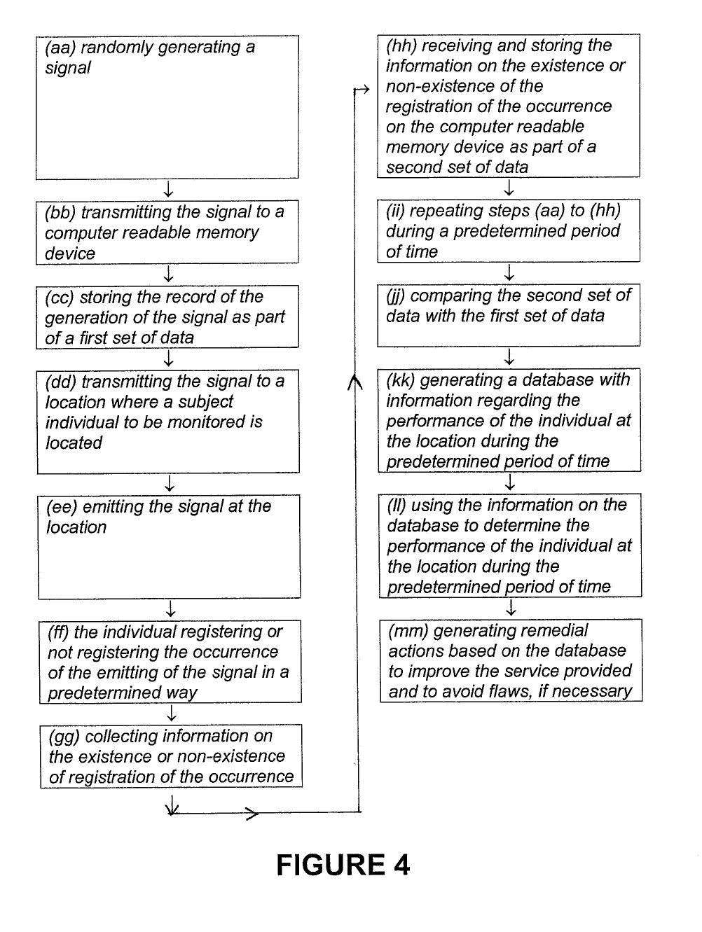

In FIG. 4, a flowchart illustrates the monitoring method of a second preferred embodiment of this invention operating with one location and one individual in that location. Thus this method starts with (aa) randomly generating a signal; (bb) transmitting the signal to computer readable memory device; (cc) storing the record of the generation of the signal as part of a first set of data; (dd) transmitting the signal to a location where a subject individual to be monitored is located; (ee) emitting the signals at the location; (ff) the individual registering or not registering the occurrence of the emitting of the signal in a predetermined way; (gg) collecting information on the existence or non-existence of the registrations of the occurrence; (hh) receiving and storing the information on the existence or non-existence of the registration of the occurrence on the computer readable memory device as part of a second set of data; (ii) repeating steps (aa) to (hh) during a predetermined period of time; (jj) comparing the second set of data with the first set of data; (kk)) generating a database with information regarding the performance of the individual at the location during the predetermined period of time; (ll) using the information on the database to determine the performance of the individual at the location during the predetermined period of time, and (mm) generating remedial actions based on the database to improve the service provided and to avoid flaws, if necessary.

In the system of the present invention a signal generator randomly generates signals during a predetermined monitoring period; a transmitter transmits these signals to a signal emitter for emitting the signals at a location where at least one subject individual to be monitored is located; a storing means then stores the recording of the generated signals during the predetermined monitoring period as a first set of data; a means for generating a predetermined response to the signal will generate a response signal in a predetermined way each time the at least one subject individual generates a response to the signal within a predetermined time after the signal is emitted; a storing means receives and stores the recording of the generated response to the signals during the predetermined monitoring period as a second set of data; and a means for comparing the first and second set of data at the end of the predetermined monitoring period of time generates an individual performance database with the performance of the at least one individual at the monitored location during the predetermined monitoring period of time.

Alternatively, in a second embodiment of the system of the present invention the means for generating a response to the signal is a registration means and will generate a registration of the occurrences of the emitting of the signals in a predetermined way each time the at least one subject individual registers the occurrences. A collecting and storing means will collect and store the information in the memory means.

Based on the information of the individual performance database it is possible to identify possible critical periods and locations in relation to each individual at each location, producing tangible economic benefits to both the service provider and the service receiver. The necessary remedial steps and actions based on the generated information can then be put in place to improve the service provided to avoid flaws, such as security gaps related to security personnel performance and activities in a location being guarded.

In the method of the present invention a random signal is generated independently of the occurrence of a problem or a potential problem with a person or a location. A record of generated signal is stored and the signal is transmitted to a signal emitter in a location where at least one individual to be monitored is located, where the signal is emitted. It is then expected that the at least one subject individual generates a response to the random signal by generating a response signal in a predetermined way within a predetermined interval after the signal is emitted.

If the predetermined response signal from the individual is generated within the predetermined interval after the random signal is emitted, there is an indication that the individual is present and alert at that location at that time. Consequently the individual and the security system can be assumed to be in condition to identify any abnormal fact or situation needing intervention of the individual, which might occur in that location at that moment or shortly thereafter. If no predictable response signal from the at least one personnel is generated within the predetermined interval after the random signal is emitted, there is an indication that the individual is either not present or not alert at that location at that time. Consequently the system may be flawed or at risk at that location at least at that moment.

Alternatively, in a second embodiment of the method of the present invention it is expected that the individual should generate a response to the signal by registering the occurrences of the emitting of the signals in a predetermined way.

In both embodiments, a plurality of random signals will be generated during a predetermined monitoring period of time. The recording of the generation of the random signals within the predetermined monitoring period of time is received and stored as a first set of data.

The recording of the responses to the signals within the predetermined monitoring period of time is also stored as a second set of data. Responses to each of the signals include, but are not limited to, generating a response signal or registering the occurrence of the emitting of the signals each time the signal is emitted.

The second set of data is then compared with the first set of data comparing the recording of the generation of signals with the recording of the generation of the responses to the signals and a database is generated with individual performance information regarding the performance of each individual at each location during the predetermined monitoring period of time.

By comparing the record of the generation of signals with the existence or non-existence of the generation of responses to the signals, the service provider is able to generate a database with the performance of each individual at the subject location. Remedial action can then be taken based on the database.

Based on the information included in the database it is possible to identify possible critical periods and locations in relation to each individual at the location, producing significant economic benefits to both the service provider and the service receiver. The necessary remedial steps and actions based on the generated information can then be put in place to improve the service provided to avoid flaws, such as security gaps related to security personnel performance and activities at a location being guarded.

If multiple locations are monitored it is possible to identify possible critical periods and locations in relation to each individual at each location, producing significant economic benefits to both the service provider and the service receiver.

The information may also be stored for later use or, in the case where response signals are expected, an immediate action from the service provider to the non-existence of a response signal is possible, identifying and solving the problem at that time at a subject location.

In a first preferred embodiment of the system of the present invention any suitable random signal generator known in the art generates a random signal. Any signal transmitter known in the art transmits the signal to a memory means and to a location where at least one subject individual is located. The memory means stores the information regarding the recording of the generation of the random signals as a first set of data. At the location any suitable signal emitting means known in the art emits the signal. A signal will be emitted at the location by a signal generating means each time a random signal from the signal generator is received at the location where the at least one subject monitored individual is located.

A means for generating a predetermined response to the signal will generate a response signal in a predetermined way every time the individual generates a response to the signal within a predetermined time after the signal is emitted, confirming the awareness and presence of the individual. The response signal may be generated by any suitable generating means, or response means, such as a switch, a screen touch key, and a keyboard key, triggered by the individual.

If there is a response to the signal from the individual, a response signal will be generated and transmitted, by any suitable response signal transmitter known in the art, to the memory means for storing the recording of the existence of the response signal generated by the individual.

The information regarding recording of the generation of the random signals during the monitoring period of time is stored in the memory means as a first set of data and the information regarding the recording of the existence of responses to the signals within the predetermined monitoring period of time is also stored in the memory means as a second set of data.

The memory means is programmed to compare the recording of the responses to the signals received and stored as the second set of data, with the recording of the generated signals stored as the first set of data, and an individual performance database is generated with information on the comparison between the existence and lack of existence of responses to the signals and consequently on the performance of the at least one individual at the location during the monitored predetermined period of time. Remedial action can then be taken based on the database.

The signal generator and the memory means may be built as one device or separate independent devices linked for cross-linking information. The signal generator and the memory means run with a computer readable software.

Alternatively, in a second preferred embodiment of the system of the present invention a means for generating a predetermined response to the signal will generate a response to the random signal by registering the occurrences of the emitting of the signals in a predetermined way and a collecting and storing means will collect and store the information in the memory means.

In a first preferred embodiment of the method of this invention a random signal is generated and transmitted to a memory means where is recorded and stored and transmitted to a location where at least one subject individual is located. In the memory means the information regarding the recording of the generation of the random signals is stored as part of a first set of data. The signal will then be emitted at the location each time a random signal from the signal generator is received at the location where the monitored individual is located.

A predetermined response to the signal from the individual is generated by generating a response signal each time the individual generates a response to the signal within a predetermined time after the signal is emitted. The response signal will be transmitted to the memory means for receiving and storing the recording of the existence of the response signal generated by the individual.

A plurality of random signals will be generated during a predetermined monitoring period of time. The information regarding the recording of the generation of the random signals during the predetermined monitoring period of time is stored in the memory means as a first set of data and the information regarding the recording of the existence of response signals within the predetermined monitoring period of time is also stored in the memory means as a second set of data.

The memory means is programmed to compare the response to the signals received and stored as the second set of data with the generated signals stored as the first set of data and an individual performance database is generated with information on the comparison between the existence and non-existence of responses to the signals and consequently on the performance of each individual at each location during the monitored predetermined monitoring period of time. Remedial action can then be taken based on the database.

The signal generator and the memory means may be built as one device or separate independent devices linked for cross-linking information. The signal generator and the memory means run with a computer readable software.

Alternatively, in a second preferred embodiment of the method of the present invention the individual registers in a predetermined way the occurrence of the emitting of the signal and collecting and storing means collect and store the registrations of the occurrence of the emitting of the signal in the memory means as part of a second set of data.

For either embodiment of the invention, a report may be generated with information regarding the performance of the individual, or a group of individuals, during the monitored period. A data outlet means linked to the memory device for processing the detection and qualification data generates a report indicating, preferably as text and number, at least the detection and qualification information data of the results. The detection and qualification data can be transferred to a remote site, if necessary.

The memory means and the data outlet means may be programmed to receive, store, retrieve and compile performance and service information for a single individual or a group of individuals, and for one or more monitored locations.

Performance and service information received and stored will identify the number of occasions of existence of responses/registrations and the number of occasions of non-existence of responses/registrations, creating a performance profile for each of the individuals, at each monitored location, during a predetermined monitoring period or interval. Averaging information may also be generated from tracking the response/non-response detection or the registration/non-registration to form an average tracking/response performance.

Based on the performance information stored in the system database the security service provider will be able to identify “critical” periods, locations and individuals of the service being provided, applicable to each subject individual and location. This information produces significant economic benefits to both the service provider and the service receiver, and provides a basis to a service provider for determining necessary actions and steps to be taken to improve the service provided and to reduce or eliminate flaws in the system. The information stored in and generated by the system database is used as a source of information related to the performance of the service provided and will be used to identify the necessary steps and actions needed to be taken to improve the service provided.

The information generated by the monitoring system can, among other things, also be used to:

a) perform a detailed and accurate individual monitoring study identifying each individual regarding performance in terms of alertness, time and speed of response and any other desired parameter, creating a performance report with multiple factors for each individual;
b) identify patterns of behaviour or circumstances that reduce the efficiency of the service activity, such as the maximum period that a regular individual will have full attention at work before stopping for a break, and
c) study patterns and identify the periods and times regularly presenting low performance for each individual and create management plans or actions to improve the service during such period or intervals.

An indirect benefit from the method of this invention is that an individual will tend to improve his attention as the monitoring signals will be emitted on a random basis, and requiring either responses or registrations, and based on awareness that his or her performance is being tested, monitored, recorded and stored.

While the present invention is discussed with particular reference to security services, it is not so restricted, and can be used for monitoring personnel in many other kinds of services.

For the purposes of this application the terms “random” and “randomly” are defined as lacking a regular plan, pattern or configuration for the generation of the signals in regard to the time of generation and target location and lacking any predetermined interval, period, bias, frequency or following a pattern previously known by the personnel being monitored. However, these signals may follow a generation configuration defined by those in charge of the generating the signals; and the terms “emitting” and “emitted” in this application are defined as being produced by any video, audio or vibration means, including, but not limited to, by displaying.

The present invention can provide for a variety of locations such as bank branches, airports, condominiums, and others. The monitoring signals will then be generated through the images being monitored through any image generating technology, analog or digital, capable of include visual signs on the images being monitored.

It should be understood that the preferred embodiments mentioned here are merely illustrative of the present invention. Numerous variations in design and use of the present invention may be contemplated in view of the following claims without straying from the intended scope and field of the invention herein disclosed.

1. A system for monitoring and managing personnel performance, the system constructed and arranged to monitor each of a plurality of individuals in each of a plurality of monitored locations, comprising:
i. a signal generator for randomly generating signals during a predetermined monitoring period;
ii. means for storing a record of the generated signals during the predetermined monitoring period as a first set of data;
iii. a transmitter for transmitting the generated signals to a signal emitter at each location;
iv. means for generating a predetermined response to each of the signals in a predetermined way each time a subject individual generates a response to one of the generated signals;
v. means for storing the responses generated by each subject individual during the predetermined monitoring period as a second set of data;
vi. means for comparing the first and second set of data at the end of the predetermined monitoring period; and
vii. means for generating an individual performance database including in relation to each monitored location during the predetermined monitoring period.

2. The system according to claim 1, wherein the individual performance database includes information on the existence or non-existence of responses to each of the signals applicable to the subject individual at each location during the predetermined monitoring period.

3. The system according to claim 1, wherein the database enables the determination of appropriate remedial steps and actions to be put in place to improve the service provided to avoid flaws.

4. The system according to claim 1, wherein the means for storing the generated signals and the generated response signals is a memory means.

5. The system according to claim 4, wherein the memory means is a computer readable memory device.

6. The system according to claim 4, further comprising a data outlet means linked to the memory means.

7. The system according to claim 6, further comprising means for processing and generating a report including the database.

8. The system according to claim 1, wherein the signals are signals selected from a group consisting of a sound, image, vibration, light, text and combinations thereof.

9. The system according to claim 1, wherein the predetermined response generation means is a response signal means.

10. The system according to claim 1, wherein the predetermined response generation means is a registration means.

11. A method for monitoring and managing personnel performance, the method comprising monitoring each of a plurality of individuals in each of a plurality of monitored locations, comprising the steps of:
(a) randomly generating a signal;
(b) storing a record of the generated signal as part of a first set of data;
(c) transmitting the generated signal to a signal emitter at each location;
(d) emitting the signals at each location;
(e) identifying whether a response is generated by the subject individual;
(f) receiving and storing as part of a second set of data any response identified in step (e);
(g) repeating steps (a) to (f) during a predetermined monitoring period;
(h) comparing the second set of data with the first set of data;
(i) generating a database with the individual performance in relation to each individual at each location during the predetermined monitoring period; and
(j) generating remedial actions based on the database.

12. The method according to claim 11, wherein the individual performance database includes information on the existence or non-existence of generated responses to each of the signals by each individual at each location during the predetermined monitoring period.

13. The method according to claim 11, wherein the individual performance database is used to determine appropriate remedial steps and actions to be put in place to improve the service provided to avoid flaws.

14. The method according to claim 11, further comprising the step of generating a report with information regarding the individual performance of each individual during the monitoring period.

15. The method according to claim 11, wherein the first and second data are stored in a memory means.

16. The method according to claim 15, wherein the memory means is a computer readable memory device.

17. The method according to claim 15, further comprising the step of linking the memory means with a data outlet means.

18. The method according to claim 17, further comprising the step of generating a report including the database compared information.

19. The method according to claim 11, wherein the signal is a signal selected from a group consisting of a sound, image, vibration, light, text and combinations thereof.

20. The method according to claim 11, further comprising the step of transferring the stored data to a remote site.

21. The method according to claim 11, wherein in step (e) the response comprises a predetermined response signal within a predetermined time after the signal is emitted.

22. The method according to claim 11, wherein in step (e) the response comprises generating a predetermined registration of the occurrence of the emitting of the signals.

23. The method according to claim 22, further including the step of collecting each generated registration.

24. The system according to claim 1, wherein the signal is generated at a remote location and transmitted to the location where the subject individual is located.

25. The system according to claim 1, wherein the signal is locally generated at each location.

26. The method according to claim 11, wherein the signal is generated at a remote location and transmitted to each location where the subject individual is located.

27. The method according to claim 11, wherein the signal is locally generated at each location where the subject individual to be monitored is located.

28. The system according to claim 1, wherein in use of the system, a plurality of random signals is generated during a predetermined monitoring period of time, the generated signals are stored creating a first set of data, the existence and non-existence of response signals or registration of the occurrence of the emitting of the signals creates a second set of data, identifiable to specific individuals and locations, the second set of data is then compared with the first set of data to determine the performance of each individual at each location during the predetermined monitoring period of time.

29. The method according to claim 11, wherein in use of the method, a plurality of random signals is generated during a predetermined monitoring period of time, the generated signals are stored creating a first set of data, the existence and non-existence of response signals or registration of the occurrence of the emitting of the signals creates a second set of data, identifiable to specific individuals and locations, the second set of data is then compared with the first set of data to determine the performance of each individual at each location during the predetermined monitoring period of time.
